(19) United States
(12) Patent Application Publication
(10) Pub. No.: US 2026/0175891 A1
(43) Pub. Date: Jun. 25, 2026

(54) SYSTEM FOR TRANSPORTING REUSABLE EQUIPMENT

(71) Applicant: SEML SEMELOG, Villeneuve-la-Garenne (FR)

(72) Inventor: Gilbert BRANCHET, Paris (FR)

(21) Appl. No.: 19/425,330

(22) Filed: Dec. 18, 2025

(30) Foreign Application Priority Data
Dec. 20, 2024 (FR) 2414837

(51) Int. Cl. B62B 3/04; B62B 3/10; B62B 3/14; B62B 3/16

(52) U.S. Cl. CPC B62B 3/04; B62B 3/10; B62B 3/1476; B62B 3/16

(57) ABSTRACT

A system for transporting equipment, includes a carrier trolley first items of equipment having different dimensions, and second item of equipment including a receptacle adapted to accommodate the first items of equipment. The carrier trolley includes a frame with a wedging member, the first items of equipment and the second item of equipment being provided respectively with a first positioning member and a second positioning member each configured to cooperate with the wedging member by engagement by complementarity of shapes. The carrier trolley selectively transports the first items of equipment and the second item of equipment, as well as the first items of equipment and the second item of equipment when the first items of equipment are housed in the receptacle of the second item of equipment.

### CROSS-REFERENCE TO RELATED APPLICATION

This application is based on and claims priority under 35 U.S.C. § 119 to French Patent Application No. 2414837, filed on Dec. 20, 2024, in the French National Intellectual Property Office, the disclosure of which is incorporated by reference herein in its entirety.

### BACKGROUND

### 1. Field

The present disclosure relates to the general field of transport and logistics.

More specifically, the present disclosure relates to a system for transporting reusable equipment, such as equipment for storing and transporting food, such as containers or lids.

The present disclosure finds a preferred, but not limiting, application in the distribution of food in institutional catering facilities, the food being stored and transported using reusable equipment.

### 2. Prior Art

In institutional catering facilities, food is typically packaged and distributed in equipment such as containers sealed with flexible plastic film. In particular, the food is first packaged in the equipment within central kitchens, then transported to the institutional catering facilities where this equipment is placed on carrier trolleys before being distributed. Once emptied, this plastic equipment is discarded, after a single use. It goes without saying that this raises ecological concerns.

To remedy this, it has been proposed to replace the plastic equipment with stainless steel equipment. Such equipment is called “reusable” because it can be cleaned and reused several times. This replacement involves the creation of a specific sector dedicated to the cleaning and storage of reusable equipment, with a cleaning and storage site as well as means for transporting reusable equipment and carrier trolleys between the cleaning and storage site, the central kitchen(s) and the institutional catering facilities.

Currently, there are several types of reusable equipment, for example stainless steel containers intended to receive food, their lids, also made of stainless steel, to close the containers, and wire crates for storing and transporting steel containers and/or their lids. The wire crates are therefore larger than the containers and lids.

When they are clean, the containers and their lids are placed either in plastic baskets sealed with plastic film and then placed on conventional pallets from the cleaning and storage site before being transported to the central kitchen using handling trolleys, either in box pallets and then placed inside box pallets before being transported from the cleaning and storage site to the central kitchen using handling trolleys. When they are dirty, the containers and their lids are placed in the wire crates, which are then placed on dollies.

The dollies are then transported empty on journeys from the cleaning and storage site (clean equipment) to the central kitchens or institutional catering facilities, while the handling trolleys are transported empty on journeys from the central kitchens or institutional catering facilities to the cleaning and storage site (dirty equipment).

In fact, the dollies are specifically adapted to the dimensions of the wire crates, while the handling trolleys are specifically adapted to the dimensions of the containers and lids. As a result, the dollies are too large to transport the containers and lids in a stable manner, while the handling trolleys are too small to accommodate the wire crates.

One disadvantage is that the quantities of equipment to be transported between cleaning and storage sites, central kitchens and institutional catering facilities are relatively large, which means that a large number of means of transport must be mobilized or a large number of trips must be made. Furthermore, box pallets are very heavy and cumbersome and have a negative impact on the consumption of means of transport. This also raises ecological concerns.

### SUMMARY

The present disclosure aims to overcome all or some of the aforementioned drawbacks of the prior art.

To this end, the present disclosure relates to a system for transporting equipment, comprising a carrier trolley and items of equipment having different dimensions, namely first item of equipment and second item of equipment, the second item of equipment comprising a receptacle adapted to accommodate the first item of equipment, the carrier trolley comprising wheels and a chassis provided with a wedging member, the first item of equipment and the second item of equipment being provided respectively with a first positioning member and a second positioning member each configured to cooperate with the wedging member of the carrier trolley by engagement by complementarity of shapes so as to immobilize one of the first item of equipment and the second item of equipment on the carrier trolley in a determined position; the carrier trolley being thus configured to selectively transport the first item of equipment and the second item of equipment, as well as the first item of equipment and the second item of equipment when the first item of equipment is housed in the receptacle of the second item of equipment.

In the system for transporting equipment according to the present disclosure, the second item of equipment is adapted to accommodate, and for example receive entirely, the first item of equipment, thus including the first positioning member. The second item of equipment therefore has dimensions greater than the overall dimensions of the first item of equipment.

The first item of equipment can be positioned and held immobile (or wedged) on the carrier trolley thanks to the cooperation of the wedging means and the first positioning member by complementarity of shapes. The second item of equipment can also be positioned and held immobile (or wedged) on the carrier trolley thanks to the cooperation of the same wedging means and the second positioning member by complementarity of shapes.

The system for transporting equipment thus allows two items of equipment of different sizes to be transported selectively, in a stable and safe manner using a single carrier trolley. In other words, the carrier trolley allows both the first and the second items of equipment to be transported in a stable and secure manner, although these items of equipment are of different dimensions. It is then no longer necessary to use trolleys specifically adapted to each item of equipment. Indeed, the first item of equipment and the second item of equipment can be transported in a stable and safe manner by the same trolley. In this way, the number of items of equipment to be transported between cleaning and storage sites, central kitchens and institutional catering facilities can be significantly reduced.

The system for transporting equipment further makes it possible to simultaneously transport the first item of equipment and the second item of equipment, with the second item of equipment which is positioned and held on the carrier trolley by the cooperation of the wedging means and the second positioning member, and with the first item of equipment which is housed in the receptacle of the second equipment.

The system for transporting equipment therefore offers a high degree of transport modularity while having a single carrier trolley, thus making the transport of the equipment relatively simple and space-saving.

Preferred, simple, convenient and economical features of the system for transporting equipment according to the present disclosure are presented hereinafter.

The first positioning member and the second positioning member may have identical dimensions.

The wedging member may have a recessed shape, while the first positioning member of the first item of equipment and the second positioning member of the second item of equipment may have a raised shape.

Conversely, the wedging member can have a raised shape, while the first positioning member of the first item of equipment and the second positioning member of the second item of equipment can have a recessed shape.

The wedging member can be defined by a vertical holding member on which the first positioning member of the first item of equipment and the second positioning member of the second item of equipment are configured to rest, and a horizontal holding member configured to prevent movement of the first item of equipment or the second item of equipment when the first positioning member or the second positioning member is resting on the vertical holding member.

The receptacle of said second item of equipment may comprise a bottom wall and side walls defining an internal receiving volume adapted to accommodate the first item of equipment, said bottom wall having an inner face facing the internal receiving volume and an outer face opposite the inner face, the second positioning member being arranged protruding on the outer face of the bottom wall.

The bottom wall can at least partially cover the horizontal holding member when the second positioning member cooperates with the wedging member of the carrier trolley.

The horizontal holding member may comprise several wedges spaced apart from each other.

The wedges may be arranged in pairs, each pair of wedges being arranged symmetrically with respect to a plane passing through a center of the wedging member.

The wedging member may be a housing, the frame of the carrier trolley defining a cavity extending between a bottom wall of the frame and said housing, said housing being open on said cavity.

The frame may be provided with a recess opening into the cavity to allow a user of the system for transporting equipment to grasp the first item of equipment or the second item of equipment when the first positioning member or the second positioning member cooperates with the wedging member of the carrier trolley.

The second positioning member may be centered on the bottom wall of the second item of equipment.

The first item of equipment may comprise a peripheral edge forming at least partially the first positioning member.

The first item of equipment may comprise at least one container and/or at least one lid.

The second positioning member may be formed by a folded metal wire

The carrier trolley may comprise a stacking member and a complementary stacking member, configured to allow the carrier trolley to be stacked with at least one other carrier trolley of the same type such that the wheels of the carrier trolley located above are at a distance from the wedging member of the carrier trolley located below.

### BRIEF DESCRIPTION OF THE DRAWINGS

Other advantages, aims and particular features of the present disclosure will appear from the following non-limiting description of at least one particular embodiment of the devices and methods forming objects of the present disclosure, with reference to the appended drawings.

FIG. 1 shows schematically, in an exploded perspective view, a system for transporting equipment according to an embodiment of the present disclosure.

FIG. 2 shows, in a perspective view, the system for transporting equipment of FIG. 1.

FIG. 3 is a view similar to FIG. 2, showing the carrier trolley of the system for transporting equipment of FIGS. 1 and 2 carrying one of the items of equipment.

FIG. 4 is a view similar to FIG. 2, showing the carrier trolley of the system for transporting equipment of FIGS. 1 and 2 carrying another of the items of equipment.

FIG. 5, FIG. 6 and FIG. 7 show in isolation the carrier trolley of the system for transporting equipment of FIGS. 1 and 2.

FIG. 8 and FIG. 9 show two carrier trolleys, identical to that of FIGS. 5 to 7, stacked on top of one another.

FIG. 10 and FIG. 11 show the carrier trolley of FIGS. 5 to 7 on which a handle is mounted.

FIG. 12 and FIG. 13 show in isolation a first item of equipment of the system for transporting equipment of FIGS. 1 and 2.

FIG. 14 is a detail view showing the cooperation between the first item of equipment and the carrier trolley of the system for transporting equipment of FIGS. 1 and 2.

FIG. 15 and FIG. 16 show in isolation second item of equipment of the system for transporting equipment of FIGS. 1 and 2.

FIG. 17 shows two second items of equipment, identical to that of FIGS. 15 and 16, stacked on top of each other.

FIG. 18 is a detail view showing the cooperation between the second item of equipment and the carrier trolley of the system for transporting equipment of FIGS. 1 and 2.

### DETAILED DESCRIPTION

As indicated previously, the present disclosure relates in general terms to a system for transporting equipment, such as so-called “reusable” equipment. However, the present disclosure is not limited to a particular type of equipment.

The present disclosure proposes providing a system for transporting equipment configured to individually wedge two items of equipment having different dimensions on the same carrier trolley, one of the items of equipment being adapted to accommodate the other of the items of equipment.

To do this, the present disclosure uses a system for transporting equipment comprising a carrier trolley and items of equipment of different dimensions, one of these items of equipment comprising a receptacle adapted to receive the other item of equipment. The carrier trolley comprises a frame and wheels. The frame comprises a wedging means and each of the items of equipment comprises a positioning member configured to cooperate with the wedging means of the carrier trolley via an engagement by complementarity of shapes, so as to immobilize the items of equipment on the carrier trolley in a determined position.

As explained below, this makes it possible to use a single carrier trolley to transport items of equipment of different sizes in a stable and safe manner, making the transport of these items of equipment relatively simple, reliable and space-saving.

Furthermore, since one of the items of equipment can be housed in the other, the system for transporting equipment is highly modular. Indeed, the system for transporting equipment can accept a first configuration in which one of the items of equipment is wedged on the carrier trolley, a second configuration in which the other item of equipment is wedged on the carrier trolley, and a third configuration in which one of the items of equipment is wedged on the carrier trolley and houses the other item of equipment.

In this document, an example of implementation of the present disclosure is described in the context of a system for transporting equipment intended for the distribution of food in institutional catering locations, where one of the items of equipment is intended to house the other item of equipment and this other equipment is intended to store food for distribution. However, the present disclosure is not limited solely to the embodiment described hereinafter and may apply more generally to a system for transporting equipment configured to transport items of equipment of different dimensions in a stable, simple and space-saving manner.

FIGS. 1 to 4 show a system for transporting equipment 1 according to a particular embodiment of the present disclosure. As illustrated in this figure, the system for transporting equipment 1 comprises a carrier trolley 10, two first items of equipment 40, 50 and a second item of equipment 60.

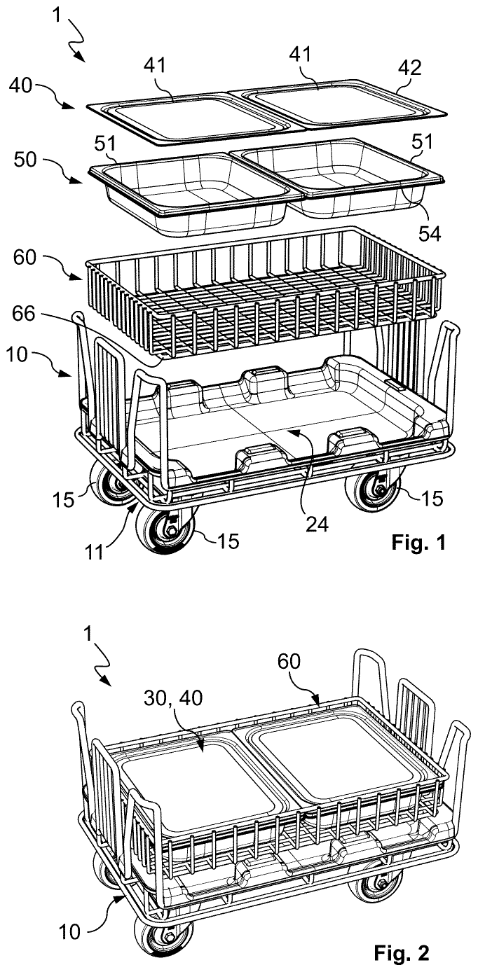

The second item of equipment 60 is configured to house at least one of the first two items of equipment 40, 50. In particular, the second item of equipment 60 comprises a receptacle having an internal receiving volume adapted to receive at least a portion of the first items of equipment 40, 50. The internal receiving volume may be greater than an overall volume of at least one of the first items of equipment, such that the first items of equipment 40, 50 are fully received in the second equipment 60. The first items of equipment 40, 50 can thus be transported inside the second item of equipment 60, as shown in FIG. 2.

In fact, the first items of equipment 40, 50 have dimensions smaller than the dimensions of the second item of equipment 60. In other words, the total volume of the first items of equipment 40, 50 is less than the total volume of the second item of equipment 60. Thus, there is a difficulty in transporting the first items of equipment 40, 50 and the second item of equipment 60 individually on the same carrier trolley, at least in a stable and safe manner. The carrier trolley 10 includes wheels 15 and a frame 14. The frame 14 is provided with a wedging member 24. Each first item of equipment 40, 50 is provided with a respective first positioning member 42, 54, while the second item of equipment 60 is provided with a second positioning member 66.

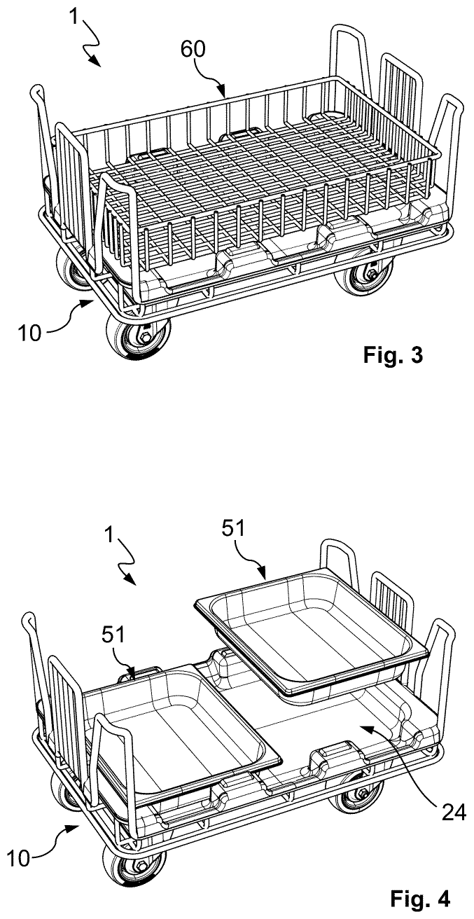

The second positioning member 66 is configured to cooperate with the wedging member 24 of the carrier trolley 10 by complementarity of shapes, so as to immobilize the second item of equipment 60 in a determined position. The second item of equipment 60 can thus be transported by the carrier trolley 10 in a stable and secure manner, housing or not the first items of equipment 40, 50, as shown in FIGS. 2 and 3 respectively.

The second item of equipment 60 can be configured to accommodate the first items of equipment 40, 50 by complementarity of shapes so as to immobilize them in a determined position. Thus, the first items of equipment 40, 50 do not move, or very little, in the second item of equipment, which is advantageous for example when the first items of equipment are fragile or are transporting fragile elements.

In the configuration shown in FIG. 2, the system for transporting equipment 1 makes it possible to transport the first items of equipment 40, 50 and the second item of equipment 60 simultaneously using the carrier trolley 10, and in a relatively compact manner in that the first items of equipment 40, 50 is housed in the second item of equipment 60. Naturally, the first items of equipment 40, 50 may be replaced by other items of equipment of different dimensions depending on the application.

It should be noted that the first positioning members 42, 54 of the first items of equipment 40, 50 are also housed in the second item of equipment 60.

The first positioning members 42, 54 are also each configured to cooperate with the wedging member 24 of the carrier trolley 10 by complementarity of shapes, so as to immobilize one of the first items of equipment 40, 50 in a determined position. The first items of equipment 40, 50 can thus be transported, individually or together, on the carrier trolley 10 in a stable and safe manner.

It should also be noted that the determined position in which the first items of equipment 40, 50 are immobilized on the carrier trolley 10 is the same as that in which the first items of equipment 40, 50 are housed in the second item of equipment 60. In other words, the second item of equipment 60 is configured to house the first items of equipment 40, 50 in the same determined position as that in which the first items of equipment 40, 50 are immobilized on the carrier trolley 10.

The wedging member 24 of the carrier trolley 10 is thus configured to cooperate both with the first positioning members 42, 54 of the first items of equipment 40, 50 and with the second item of equipment 60 by complementarity of shapes so as to immobilize them, selectively, on the carrier trolley 10 in a determined position, although the first items of equipment 40, 50 and the second item of equipment 60 are of different dimensions.

Each of the first items of equipment 40, 50 and the second item of equipment 60 can thus be transported in a stable and safe manner by a single carrier trolley 10, which makes it possible to limit the quantity of material for transporting this equipment.

In the example shown, the wedging member 24 has a recessed shape, while the first positioning member 42, 54 and the second positioning member 66 each have a raised shape.

In particular, as the system for transporting equipment 1 is here intended for the distribution of food in institutional catering locations, one of the first items of equipment 50 is formed by two stainless steel containers 51 while the other one of the first items of equipment 40 is formed by two stainless steel lids 41, each being configured to close one of the containers 51. The second item of equipment is formed by a wire crate 60 adapted to house the two containers 51 and/or the two lids 41, for example when the latter are dirty, i.e. after storing food.

One of the first positioning members 42, 54 is formed by a part of the peripheral edges of the lids 41 while the other of the first positioning members 42, 54 is formed by a part of the peripheral edges of the containers 51. The second positioning member 66 is formed by a first folded metal wire.

However, the present disclosure is not limited to this equipment, nor to these positioning members. For example, the first item of equipment may be formed by a single container and/or by a single lid. More generally, other types of equipment and positioning members may be envisaged depending on the application of the system for transporting equipment.

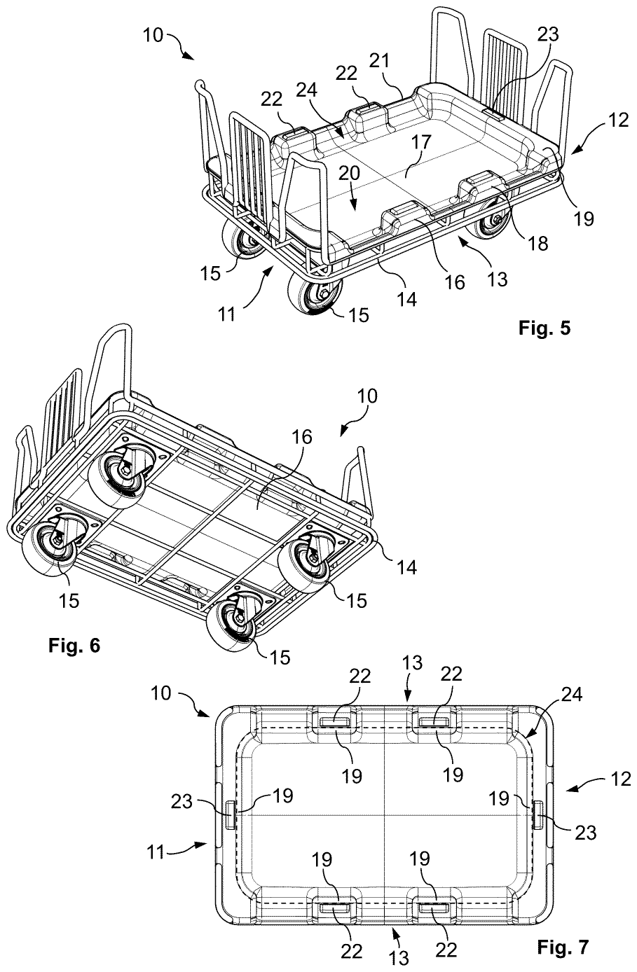

FIGS. 5 to 11 show in isolation the carrier trolley 10 of the system for transporting equipment 1 of FIGS. 1 to 4.

The carrier trolley 10 has a front side 11, a rear side 12 opposite the front side 11 and opposite lateral sides 13 each connecting the front side 11 to the rear side 12.

As indicated previously, the carrier trolley 10 comprises a frame 14 and wheels 15, attached to the frame, and four in number, distributed in pairs.

The frame 14 is roughly in the form of a tray. In the example shown, the frame 14 comprises a lattice structure of metal rods welded at their intersections as well as a protective plate 16 covering the lattice structure to prevent dirt projected by the wheels 15 from contaminating the food placed on the carrier trolley 10.

The protective plate 16 comprises a bottom face 17, a peripheral edge 18 extending at the periphery and protruding from the bottom face 17, and wedges 22, 23 arranged protruding on an upper face 19 of the peripheral edge 18.

The wedges 22, 23 define with each other, and with the upper face 19 of the peripheral edge 18, a housing 24 configured to cooperate with the first positioning members 42, 54 of the first items of equipment 40, 50 and with the second positioning member 66 of the second item of equipment 60 so as to immobilize one of the first items of equipment 40, 50 and the second item of equipment 60 on the carrier trolley 10 in a determined position. The housing 24 therefore constitutes a wedging member within the meaning of the present disclosure.

Some wedges 22 are disposed along the lateral sides 13, while other wedges 23 are disposed along the front sides 11 and rear sides 12, so as to immobilize the first items of equipment 40, 50 or the second item of equipment 60 laterally, i.e. along the upper face 19 of the peripheral edge 18. In particular, the wedges 22, 23 are arranged in pairs, each pair of wedges being arranged symmetrically with respect to a plane passing through a center of the housing 24.

In the example shown, the wedges 22, 23 are spaced apart from each other. However, it is conceivable that the carrier trolley includes a single wedge, extending continuously, at least partially delimiting the housing.

The peripheral edge 18 defines a cavity 20 and is provided with recesses 21 opening into the cavity 20 to allow a user of the system for transporting equipment 1 to grip the first items of equipment 40, 50 or the second item of equipment 60 when this equipment is immobilized on the carrier trolley 10. In the example shown, the recesses 21 are provided in the peripheral edge 18 at each lateral side 13 and have an overall square shape, imparting to the peripheral edge 18 a crenelated shape. Shapes other than recesses may be envisaged to allow gripping of equipment when it is immobilized on the trolley. In general, an opening emerging in the cavity is sufficient to allow a user to grasp one of the items of equipment.

The protective plate 16 is optional. Thus, the bottom face 17, the peripheral edge 18 and the wedges 22, 23 can be formed by the lattice structure or by any other structure forming the frame 14 of the carrier trolley 10.

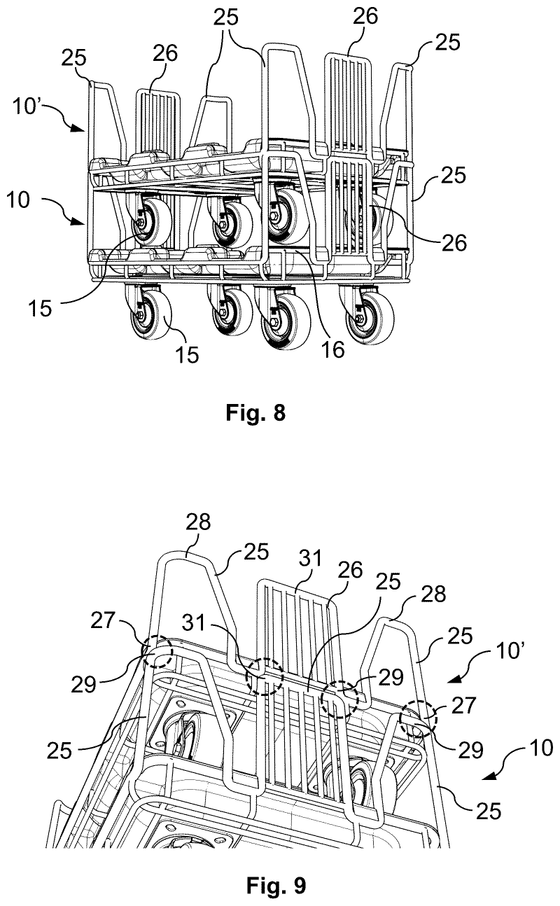

With reference to FIGS. 8 and 9, the frame 14 further comprises first posts 25 and second posts 26 extending protruding from the lattice structure.

As illustrated in FIG. 9, the first posts 25, each comprise a lower portion 27 located on the side of the frame 14 and an upper portion 28 forming a distal end of the first posts 25 relative to the frames 14. The lower portion 27 and the upper portion 28 are configured to allow stacking of the carrier trolley 10 with at least one other carrier trolley 10′ of the same type, such that the wheels 15 of the carrier trolley 10′ located above are at a distance from the protective plate 16 of the carrier trolley 10 located below. This configuration makes it possible to transport a plurality of carrier trolleys 10, 10′ compactly, by stacking them, while guaranteeing a good level of hygiene by avoiding contact between the wheels, which can carry dirt due to their repeated contact with the ground, and the protective plate, receiving the equipment.

In particular, the upper portion 28 of each first post 25 of the carrier trolley 10 located below is configured to bear against the lower portion of corresponding first posts of the carrier trolley 10′ located above, so as to immobilize the carrier trolley 10′ located above on the carrier trolley 10 located below in a stacked configuration in which the wheels of the carrier trolley 10′ do not touch the protective plate 16 of the carrier trolley 10 located below.

The first posts 25 are here four in number and are disposed at each corner of the carrier trolley 10 to guarantee good stability of the stack of carrier trolleys 10, 10′.

The second posts 26 also each comprise a lower portion 29 located on the side of the frame 14 and an upper portion 31 forming a distal end of the second posts 26 relative to the frames 14. The lower portion 29 and the upper portion 31 are configured to allow stacking of the carrier trolley 10 with at least one other carrier trolley 10′ of the same type, such that the wheels 15 of the carrier trolley 10′ located above are at a distance from the protection plate 16 of the carrier trolley 10 located below.

In particular, the upper portion 31 of each second posts 26 of the carrier trolley 10 located below is configured to bear against the lower portion of corresponding first posts of the carrier trolley 10′ located above, so as to immobilize the carrier trolley 10′ located above on the carrier trolley 10 located below in a stacked configuration in which the wheels of the carrier trolley 10′ do not touch the protective plate 16 of the carrier trolley 10 located below.

The contact areas between the first posts 25 and the second posts 26 of the carrier trolleys 10, 10′ are indicated by circles in a dotted line in FIG. 9.

The second posts 26 are here two in number and are disposed one on the front side 11 of the carrier trolley 10, between first posts 25, and the other on the rear side 12 between other first posts 25. The second posts 26 are not necessary for stacking the carrier trolleys, but improve the stability of the stack and reduce the risk of falling.

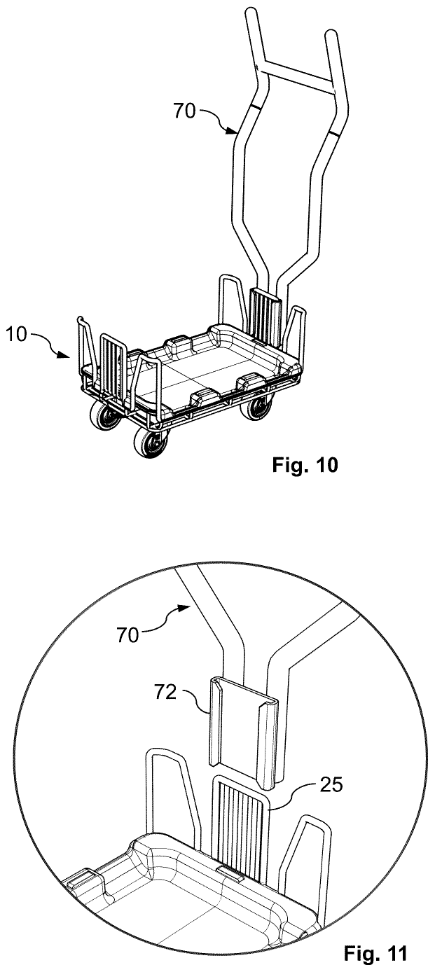

As illustrated in FIGS. 10 and 11, the carrier trolley 10 may comprise a handle 70, or a bar, to allow a user of the system for transporting equipment 1 to pull or push the carrier trolley 10 in a desired direction.

In the example shown, the handle 70 is removably mounted on the frame 14 of the carrier trolley 10. The handle 70 may be fixed or articulated relative to the frame 14. The handle 70 here includes two arms extending roughly parallel to one another, but other types of handle well known to those skilled in the art may of course be considered.

The handle 70 includes a mounting member 72 configured to cooperate with one of the second posts 26 for mounting the handle on the frame 14 of the carrier trolley 10.

The mounting member 72 is here configured to engage, by sliding, on the second post 26 of the frame 14, in an engagement direction ranging from the upper part 31 of the second post 26 to its lower part 29 until it abuts against the frame 14. For this purpose, the mounting member 72 has for example a C-shaped profile, configured to form a slide connection with the second post 26.

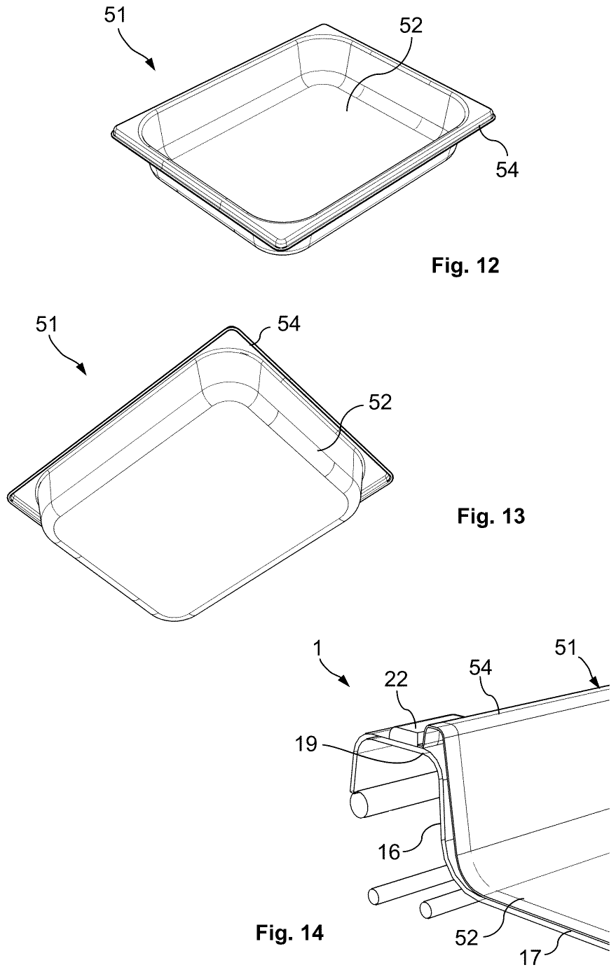

FIGS. 12 to 14 show in isolation a container 51, here partially forming the first item of equipment 50 of the system for transporting equipment 1 of FIG. 1.

Each container 51 comprises a receiving portion 52 and a edge 54, roughly flat, extending protruding from the receiving portion 52 to allow a user to carry the container or to rest the container on rails. The receiving portion 52 extends in a direction roughly perpendicular to the edge 54.

In the example illustrated in FIG. 1, the first item of equipment 50 is formed by two containers 51 juxtaposed, so as to form an external contour of an overall rectangular shape defined by the edges 54 of the containers.

This external contour defined by the edges 54 of the containers 51 is configured to cooperate with the wedging member 24 of the carrier trolley 10 by complementarity of shapes so as to immobilize the containers 51 in a determined position, which here corresponds to the configuration shown in FIGS. 1 and 2 in which the containers 51 are juxtaposed. By juxtaposing the containers 51, or arranging their edge against each other, the clearance separating them is limited and the containers 51 remain substantially immobile on the carrier trolley 10, even when the latter is moved.

The first positioning member 54 is thus formed by this outer contour defined by the edges 54 of the juxtaposed containers 51. The edges 54 of the containers 51 which are juxtaposed, or against one another, do not define the first positioning member 54.

The edge 54 of each container 51 is thus configured to occupy in only a portion of the housing 24 of the carrier trolley 10. Since the containers 51 are identical here, each edge 54 is configured to occupy half of the housing 24 of the carrier trolley 10.

The containers 51 can of course be of different dimensions, as long as the edges 54 cooperate by complementarity of shapes with the housing 24 of the carrier trolley 10 when the containers are juxtaposed. The number of containers 51 may also vary. According to an example not shown, the first item of equipment may be formed by more than two containers. According to another example not shown, the first item of equipment may be formed by a single container, the edge of which is configured to cooperate by complementarity of shapes with the housing of the carrier trolley.

In the example shown, the edge 54 of each container 51 extends continuously to the periphery of the receiving portion 52. However, the edge may extend discontinuously to the periphery of the receiving portion. In other words, the edge may be formed by several elements spaced apart from each other arranged at the periphery of the receiving portion.

FIG. 14 shows in more detail the cooperation by complementarity of shapes between the edge 54 of one of the containers 51 and the housing 24 of the carrier trolley 10. The edge 54 of each container 51 is bearing on the upper face 19 of the peripheral edge 18 of the carrier trolley 10, and disposed between the wedges 22, 23, although not all of them are shown here, so that the containers 51 are immobilized in a determined position on the carrier trolley 10.

The movement of the container 51 along the upper face 19 is limited by the wedges 22, 23. The distance between the edge 54 and the wedges 22, 23 is preferably chosen as small as possible to limit the movement of the container 51 on the carrier trolley 10, for example when the latter accelerates, slows down or turns.

The frame 14 is configured so that, in the operating position of the carrier trolley 10, shown in FIGS. 1 to 4, the container 51 is held in abutment on the upper face 19 by gravity. The height of the wedges 22, 23, defined along a direction substantially perpendicular to the upper face 19, is chosen so as to prevent an edge 54 from passing over the wedges. The face of the wedges 22, 23 which is facing, or in contact, with the edge 54 is preferably substantially perpendicular to the upper face 19 to prevent sliding of the edge on this face.

Thus, the upper face 19 of the peripheral edge 18 constitutes a vertical holding member on which the edge 54 of each container 51 is configured to rest, while the wedges 22, 23 constitute a horizontal holding member configured to prevent the movement of the containers 51 when the edges 54 rest on the upper face 19.

The receiving portion 52 of the containers 51 is received in the cavity 20 and is located at a distance from the bottom face 17 of the frame 14 to guarantee that the edge 54 of each container 51 is in abutment on the upper face 19 of the peripheral edge 18.

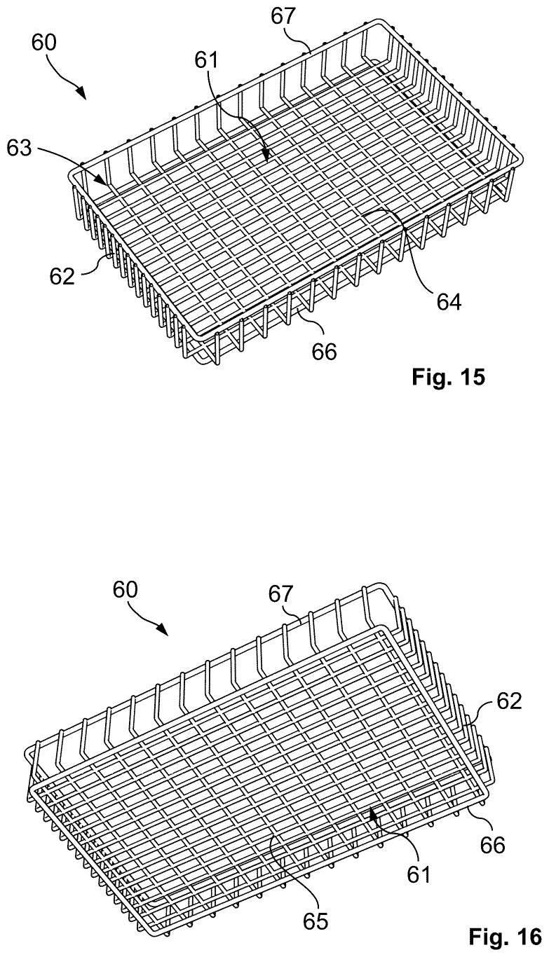

FIGS. 15 to 18 show in isolation the wire crate 60, forming here the second item of equipment of the system for transporting equipment 1 of FIG. 1.

The wire crate 60 comprises a bottom wall 61 and side walls 62 connected to each other and extending from the bottom wall 61 to define an internal receiving volume 63, as well as an opening defined by the side walls 62 facing the bottom wall, to access the internal receiving volume. In the example shown, the wire crate 60 comprises a lattice structure of metal rods welded at their intersections.

The internal receiving volume 63 is adapted to house, for example entirely, the containers 51, at least when they are in the determined position in which they cooperate by complementarity of shapes with the housing 24 of the carrier trolley 10, shown in FIGS. 1 and 2. In other words, the internal reception volume 63 of the wire crate 60 is greater than the overall volume of the containers 51 in the previously mentioned determined position. The containers 51 can thus be received in the internal receiving volume 63 without protruding from the wire crate 60 through the opening.

The first folded metal wire 66 is configured to cooperate with the wedging member 24 of the carrier trolley 10 by complementarity of shapes so as to immobilize the wire crate 60 in a determined position, which here corresponds to the configuration shown in FIGS. 1 and 2 in which the bottom wall 61 is on the side of the carrier trolley 10. The second positioning member is thus formed by the first folded metal wire 66.

The bottom wall 61 has an inner face 64 facing the inner receiving volume 63 and an outer face 65 opposite the inner face 64. The outer face 65 is facing the carrier trolley 10 in the configuration mentioned above. The first folded metal wire 66 is arranged protruding on the outer face 65 of the bottom wall 61 of the wire crate 60. Thus, when the first folded metal wire 66 cooperates with the housing 24 of the carrier trolley 10, the opening is oriented upwards and the containers 51 are held in the wire crate 60 by the side walls 62, for example when the carrier trolley 10 accelerates, decelerates or turns.

In addition, the arrangement of the first folded metal wire 66 protruding on the outer face 65 of the bottom wall 61 does not affect the internal receiving volume 63. In other words, the internal receiving volume 63, and more generally the dimensions of the wire crate 60, are not constrained by the dimensions of the first folded metal wire 66.

In the example shown, the first folded metal wire 66 extends continuously and closes on itself while defining here an overall rectangular shape. However, the first folded metal wire can extend discontinuously, i.e. formed by several elements spaced apart from each other protruding from the outer face 65 of the bottom wall 61.

The first folded metal wire 66 has dimensions similar to those of the contour formed by the edges 54 of the containers described previously. The housing 24 is therefore configured to cooperate with the contour formed by the edges 54 of the containers 51 and with the first folded metal wire 66 without any adjustment. More generally, the carrier trolley 10 does not require any setting or adjustment to immobilize the containers 51 or the wire crate 60 in their respective determined positions, making the system for transporting equipment 1 very simple to use.

The wire crate 60 further comprises a second folded metal wire 67 disposed on the side walls 62 inside the internal receiving volume 63 and configured to allow the wire crate 60 to be stacked with at least one other wire crate 60′ of the same type. This configuration makes it possible to transport a plurality of wire crates 60, 60′, in a stable and compact manner.

In particular, the second folded metal wire 67 defines a housing in which the first folded metal wire 66 is configured to engage by complementarity of shapes. The dimensions of the first folded metal wire 66 are therefore slightly smaller than those of the second folded metal wire 67.

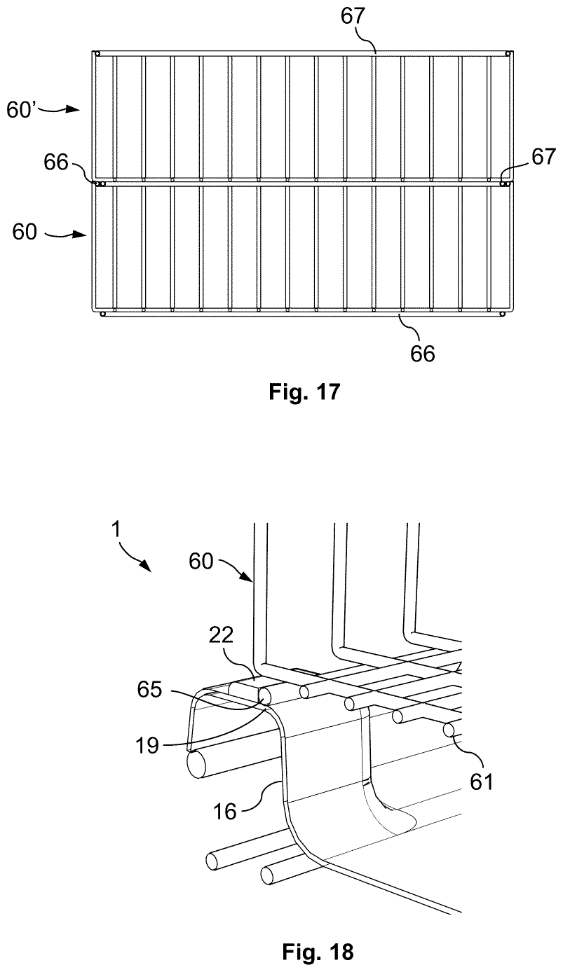

In the stacked configuration shown in FIG. 17, the bottom wall 61 of the wire crate 60′ located above is in abutment against the side walls 62 of the wire crate 60 located below to hold the first folded metal wire 66 of the wire crate 60′ located above in the housing defined by the second folded metal wire 67 of the wire crate located below. The cooperation between the first folded metal wire 66 of the wire crate 60′ located above and the second folded metal wire 67 of the wire crate 60 located below thus defines an embedding connection, ensuring the stability of the stack.

FIG. 18 shows in more detail the cooperation by complementarity of shapes between the first folded metal wire 66 of the wire crate 60 and the housing 24 of the carrier trolley 10. The first folded metal wire 66 is in abutment on the upper face 19 of the peripheral edge 18 of the carrier trolley 10, and is disposed between the wedges 22, 23, although not all of them are shown here, so that the wire crate 60 is immobilized in a determined position on the carrier trolley 10.

The movement of the wire crate 60 along the upper face 19 is limited by the wedges 22, 23. The distance between the first folded metal wire 66 and the wedges 22, 23 is preferably selected as small as possible to limit the movement of the wire crate 60 on the carrier trolley 10, for example when the latter accelerates, slows down or turns.

The frame 14 is configured so that, in the operating position of the carrier trolley 10, shown in FIGS. 1 to 4, the wire crate 60 is held in abutment on the upper face 19 by gravity. The height of the wedges 22, 23, defined along a direction substantially perpendicular to the upper face 19 is selected so as to prevent the first folded metal wire 66 from passing over the wedges. The face of the wedges 22, 23 which is facing, or in contact with, the first folded metal wire 66 is preferably substantially perpendicular to the upper face 19 to prevent sliding of the first folded metal wire 66 on this face.

Thus, the upper face 19 of the peripheral edge 18 constitutes a vertical holding member on which the folded metal wire 66 of the wire crate 60 is configured to rest, while the wedges 22, 23 constitute a horizontal holding member configured to prevent the movement of the wire crate 60 when the folded metal wire 66 rests on the upper face 19.

The bottom wall 61 of the wire crate 60 at least partially covers part, or all, of the wedges 22, 23. In fact, the shape defined by the first folded metal wire 66 only occupies part of the bottom wall 61 of the wire crate 60. The first folded metal wire 66 is here centered on the bottom wall 61 to improve the balance of the wire crate 60 on the carrier trolley 10.

The bottom wall 61 of the wire crate is located at a distance from the bottom face 17 of the frame 14 to guarantee that the first folded metal wire 66 is in abutment on the upper face 19 of the peripheral edge 18.

In general, the containers 51 can be positioned and held immobile (or wedged) on the carrier trolley 10 thanks to the cooperation of the housing 24 and the edges 54 by complementarity of shapes. The wire crate 60 can also be positioned and held immobile (or wedged) on the carrier trolley 10 thanks to the cooperation of the same housing 24 and the folded metal wire 66 by complementarity of shapes.

Thus, the system for transporting equipment 1 makes it possible to selectively transport, in a stable and safe manner, two items of equipment 40, 50, 60 of different dimensions using a single carrier trolley 10. In other words, the carrier trolley 10 makes it possible to transport both the containers 51 and/or the lids 41 and the wire crate 60 in a stable and secure manner, although these items of equipment are of different dimensions. It is then no longer necessary to use trolleys specifically adapted to each item of equipment. This is because the containers 51 and the wire crate 60 can be transported in a stable and secure manner by the same carrier trolley 10. In this way, the amount of equipment to be transported between cleaning and storage sites, central kitchens and institutional catering facilities can be significantly reduced.

The system for transporting equipment 1 further makes it possible to simultaneously transport the containers 51 and/or the lids 41 and the wire crate 60, with the wire crate 60 positioned and held immobile on the carrier trolley 10 by the cooperation of the housing 24 and the first folded metal wire 66, and with the containers 51 and/or the lids 41 housed in the receptacle of the wire crate 60.

The system for transporting equipment 1 therefore offers great transport modularity while having a single carrier trolley 10, thus making the transport of the items of equipment 40, 50, 60 relatively simple and space-saving.

Alternatives not illustrated are described hereinafter.

The first item of equipment and the second item of equipment may be different, depending on the application of the system for transporting equipment.

The wedging member may be raised, while the first positioning member and the second positioning member are recessed. In the illustrated example embodiment, the wedging member is recessed (housing), while the first positioning member and the second positioning member are raised (or protruding).

The first positioning member, the second positioning member, and the wedging member may have a different shape, for example circular, triangular, or any other shape, rather than a rectangular shape.

The wedges can be formed directly by the structure of the frame of the carrier trolley.

The handle can be mounted on the carrier trolley in various ways. For example, the mounting member of the handle can be configured to cooperate with the first posts, such that the first posts serve both as stacking members and as complementary mounting members for mounting the handle on the frame of the carrier trolley.

More generally, the present disclosure is not limited to the examples described and shown.

What is claimed is:

1. A system for transporting equipment, comprising a carrier trolley and items of equipment having different dimensions, namely first item of equipment and second item of equipment, the second item of equipment comprising a receptacle adapted to fully receive the first item of equipment, the carrier trolley comprising wheels and a frame provided with a wedging member, the first item of equipment and the second item of equipment being provided, respectively, with a first positioning member and a second positioning member each configured to cooperate with the wedging member of the carrier trolley by engagement by complementarity of shapes so as to immobilize one of the first item of equipment and the second item of equipment on the carrier trolley in a determined position; the carrier trolley being thus configured to selectively transport the first item of equipment and the second item of equipment, as well as the first item of equipment and the second item of equipment when the first item of equipment is housed in the receptacle of the second item of equipment.

2. The system for transporting equipment according to claim 1, characterized in that the first positioning member and the second positioning member have identical dimensions.

3. The system for transporting equipment according to claim 1, characterized in that the wedging member has a recessed shape, while the first positioning member of the first items of equipment and the second positioning member of the second item of equipment have a raised shape.

4. The system for transporting equipment according to claim 3, characterized in that the wedging member is defined by a vertical holding member on which the first positioning member of the first items of equipment and the second positioning member of the second item of equipment are configured to rest, and a horizontal holding member configured to prevent movement of the first items of equipment or the second item of equipment when the first positioning member or the second positioning member rests on the vertical holding member.

5. The system for transporting equipment according to claim 4, characterized in that the receptacle of said second item of equipment comprises a bottom wall and side walls defining an internal receiving volume adapted to accommodate the first items of equipment, said bottom wall having an internal face facing the internal receiving volume and an external face opposite the internal face, the second positioning member being arranged protruding on the outer face of the bottom wall.

6. The system for transporting equipment according to claim 5, characterized in that the bottom wall at least partially covers the horizontal holding member when the second positioning member cooperates with the wedging member of the carrier trolley.

7. The system for transporting equipment according to claim 4, characterized in that the horizontal holding member comprises several wedges spaced apart from each other.

8. The system for transporting equipment according to claim 7, characterized in that the wedges are arranged in pairs, each pair of wedges being arranged symmetrically with respect to a plane passing through a center of the wedging member.

9. The system for transporting equipment according to claim 1, characterized in that the wedging member is a housing, the frame of the carrier trolley defining a cavity extending between a bottom wall of the frame and said housing, said housing being open onto said cavity.

10. The system for transporting equipment according to claim 7, characterized in that the frame is provided with a recess opening into the cavity to allow a user of the transport system to grip the first items of equipment or the second item of equipment when the first positioning member or the second positioning member cooperates with the wedging member of the carrier trolley.

11. The system for transporting equipment according to claim 5, characterized in that the second positioning member is centered on the bottom wall of the second item of equipment.

12. The system for transporting equipment according to claim 1, characterized in that the first equipment comprises a peripheral edge at least partially forming the first positioning member.

13. The system for transporting equipment according to claim 12, characterized in that the first items of equipment comprises at least one container and/or at least one lid.

14. The system for transporting equipment according to claim 1, characterized in that the second positioning member is formed by a folded metal wire.

15. The system for transporting equipment according to claim 1, characterized in that the carrier trolley comprises a stacking member and a complementary stacking member, configured to allow the carrier trolley to be stacked with at least one other carrier trolley of the same type so that the wheels of the carrier trolley located above are at a distance from the wedging member of the carrier trolley which is located below.
